(19) United States
(12) Patent Application Publication
(10) Pub. No.: US 2002/0153392 A1
(43) Pub. Date: Oct. 24, 2002

(54) Compressed air discharge device

(76) Inventor: David Wayne Casella, Sorrento, Western Australia (AU)

Correspondence Address: MARGER JOHNSON & MCCOLLOM PC, 1030 SW MORRISON STREET, PORTLAND, OR, 97205, US

(21) Appl. No.: 09/959,053

(22) PCT Filed: Feb. 15, 2001
(86) PCT No.: PCT/AU01/00153

(30) Foreign Application Priority Data
Feb. 15, 2000 (AU) PQ 5655

(51) Int. Cl. B05B 7/00

(52) U.S. Cl. 222/630

(57) ABSTRACT

(57) Abstract: A compressed air discharge device (1) having an inlet (6) for entry of air into the device (1) and an outlet (8) for discharge of air from the device (1). First, second, third and fourth passages (10, 12, 14, 16) are provided for flow of air. A first valve (18) controls flow of air from the first passage (10) to the third passage (14). A second valve (20) controls passage of air from the third passage (14) to the fourth passage (16). T he first passage (10) is provided between the inlet (6) and the first valve (18). The third passage (14) is provided between the first and second valves (18, 20). The fourth passage (16) is provided between the second valve (20) and the outlet (8). A trigger (36) operates the first valve (18) to allow air to flow therethrough into the second and third passages (12, 14). The second passage (12) is arranged so that air is able to enter the second passage (12) upon the first valve (18) being opened. A chamber (60) is formed within the device (1) and the second passage (12) leads to the chamber (60). A piston (56) is movable by air entering the chamber (60). Operation of the trigger (36) opens the first valve (18) to allow air to flow therethrough from the first passage (10) into the second and third passages (12, 14). The air flows along the second passage (12) to the chamber (60) to cause the piston (56) to move which causes the second valve (20) to open and allow air to flow therethrough from the third passage (14) to the fourth passage (16) and to be discharged from the outlet (8).

### FIELD OF THE INVENTION

The present invention relates to a compressed air discharge device. The compressed air discharge device of the present invention is arranged to be connected, via an inlet, to a supply of compressed air. The compressed air is then discharged from an outlet of the device. The outlet of the compressed air discharge device may be connected with a pipe or conduit. The outlet of the device may be connected with a pipe or conduit to launch a projectile along the pipe or conduit. The projectile may be a cleaning pellet that travels along the pipe or conduit to clean the pipe or conduit. The compressed air discharge device may be connected to the pipe or conduit directly or via an intermediate adaptor assembly.

### DISCLOSURE OF THE INVENTION

In accordance with one aspect of the present invention, there is provided a compressed air discharge device comprising

an inlet for entry of air into said device,

an outlet for discharge of air from said device,

first, second, third and fourth passage means for flow of air,

first valve means to control flow of air from said first passage means to said third passage means,

second valve means to control flow of air from said third passage means to said fourth passage means,

said first passage means provided between said inlet and said first valve means, said third passage means provided between said first and second valve means, and said fourth passage means provided between said second valve means and said outlet,

trigger means operable to open said first valve means to allow air to flow therethrough into said second and third passage means,

said second passage means arranged such that air is able to enter said second passage means upon said first valve means being opened,

a chamber formed within said device and said second passage means leading to said chamber, and

piston means movable by air entering said chamber,

wherein, in use, operation of said trigger means opens said first valve means to allow air to flow therethrough from said first passage means into said second and third passage means, and air flows along said second passage means to said chamber to cause said piston means to move in a first direction from a first position to a second position which causes said second valve means to open and allow air to flow therethrough from said third passage means to said fourth passage means and to be discharged from said outlet.

Preferably, the inlet to said second passage means is provided adjacent said first valve means.

Preferably, a second chamber is provided on, the side of said piston means opposed to said chamber and said second chamber is provided with venting means.

The air that flows into said third passage means from said first passage means upon said first valve means being opened, acts to maintain the second valve means in a closed condition until said second valve means is opened.

The piston means moves in the said first direction which is opposed to the direction of air flow along the fourth passage means.

Preferably, said second valve means comprises a valve head and a valve seat, and a valve stem extends from said valve head and is attached to said piston means.

Preferably, when said second valve means opens, said valve head moves in said first direction which is opposed to the direction of airflow along the fourth passage means.

The first and second valve means are biased into respective closed positions.

Preferably, said first and second valve means are provided with springs to bias them into their closed conditions.

### BRIEF DESCRIPTION OF THE DRAWINGS

The present invention will now be described, by way of example, with reference to the accompanying drawings, in which:

FIG. 1 is a first perspective view of an embodiment of the compressed air discharge device of the present invention;

FIG. 2 is a second perspective view of the compressed air discharge device shown in FIG. 1;

FIG. 3 is a first end view of the compressed air discharge device shown in FIG. 1;

FIG. 4 is a cross-sectional view taken along the line B-B shown in FIG. 3 in a first condition of operation of the compressed air discharge device;

FIG. 5 is a second cross-sectional view taken along the line B-B in FIG. 3 showing the compressed air discharge device in a third condition of operation;

FIG. 6 is a second end view of the compressed air discharge device shown in FIG. 1;

FIG. 7 is a first cross-sectional view taken along the line A-A in FIG. 6 with the compressed air discharge device in the first condition of operation; and

FIG. 8 is a second cross-sectional view taken along the line A-A in FIG. 6 showing the compressed air discharge device in a second condition of operation.

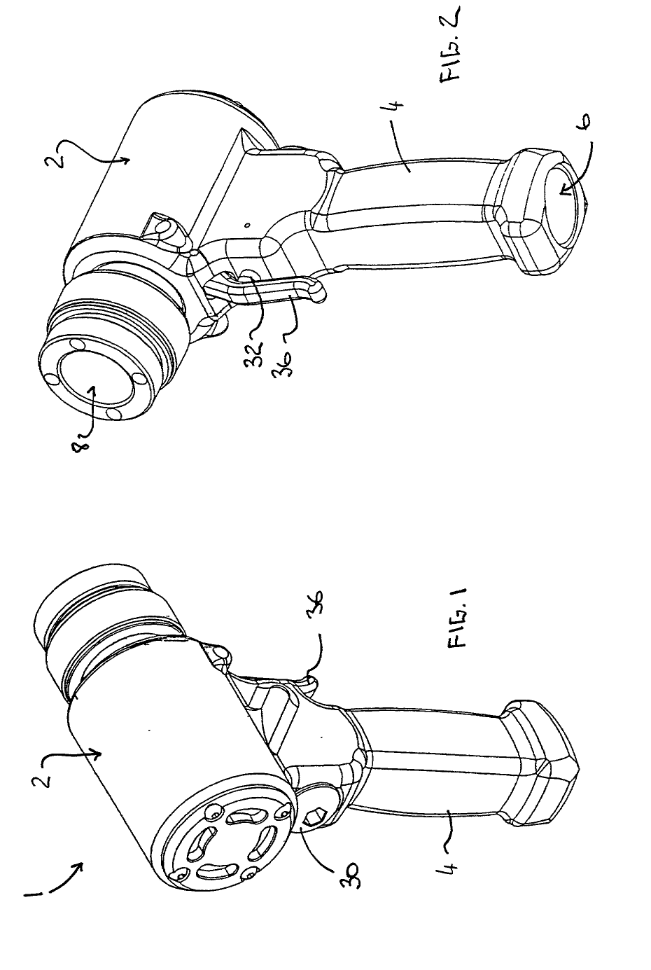

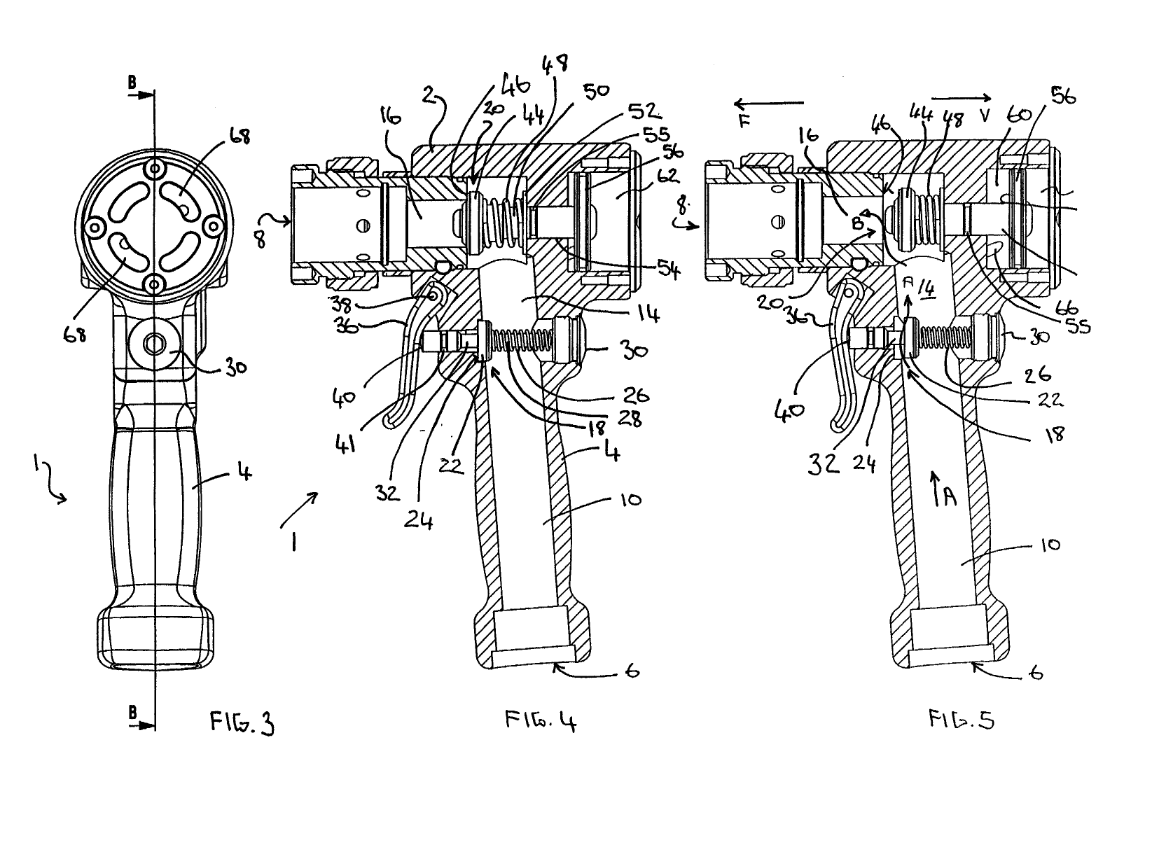

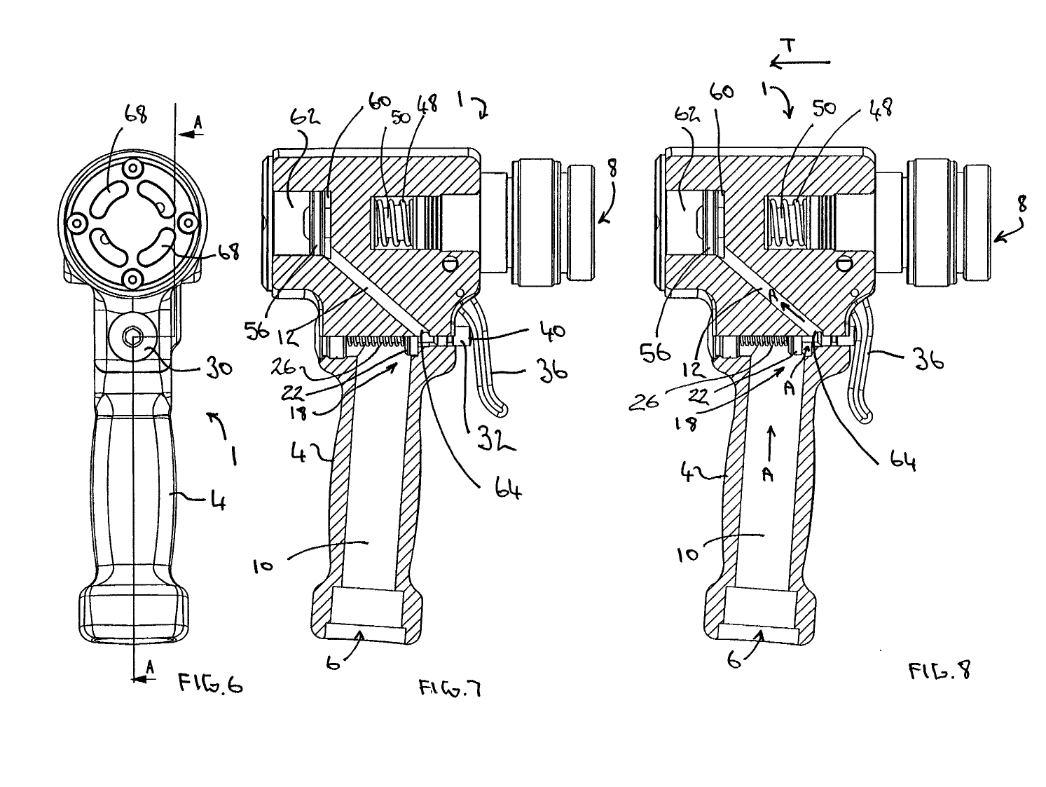

### BEST MODE (s) FOR CARRYING OUT THE INVENTION

In the drawings, there is shown a compressed air discharge device 1 comprising a body 2, part of which forms a handle 4 arranged to be gripped by an operator. The device 1 is provided with an inlet 6 for entry of air into the device 1 and an outlet 8 for discharge of air from the device 1. First, second, third and fourth passages 10, 12, 14 and 16, respectively, are provided for flow of air. A first valve 18 controls the flow of air from the first passage 10 to the second passage 12 and third passage 14. A second valve 20 controls flow of air from the third passage 14 to the fourth passage 16.

The first valve 18 comprises a valve head 22 which seats against a valve seat 24. The valve head 22 is biased against the valve seat 24 by a spring 26. The spring 26 is carried by a valve stem 28 of the first valve 18. The spring 26 extends between the valve head 22 and a stop 30. A pin 32 extends from the face of the valve head 22 that is opposed to the face from which the valve stem 28 extends. The pin 32 extends from the body 2 of the device 1 via an opening 34 in the body 2.

A trigger 36 is pivotally attached to the body 2 by way of a pivotal connection 38. The trigger 36 rests upon the end 40 of the pin 32 that extends from the opening 34. A seal 42 is provided around the pin 32 and seals with the wall of the opening 34 in the body 2.

The valve 20 comprises a valve head 44 and a valve seat 46 against which the valve head 44 seats. The valve head 44 is biased against the valve seat 46 by a spring 48. The spring 48 is carried by a valve stem 50 of the second valve 20. The spring 48 extends between the valve head 44 and a stop 52. The valve stem 50 extends through a bore 54 in the body 2 of the device 1. A seal 55 is provided around the pin 50 and seals with the wall of the bore 54.

A piston 56 is provided at the end of the valve stem 50 opposed to the valve head 44. The valve stem 50 connects the valve head 44 and the piston 56. The piston 56 and internal surfaces 58 of the body 2 form a first chamber 60. The first chamber 60 is formed on the side of the piston 56 having the face 61 to which the valve stem 50 is connected. A second chamber 62 is provided on the side of the piston 56 opposed to the first chamber 60.

The first passage 10 extends from the inlet 6 to the first valve 18.

The second passage 12 is arranged such that air is able to enter the second passage 12 upon the first valve 18 being opened. The second chamber 12 has an inlet 64 that is located adjacent the first valve 18. The second passage extends from the inlet 64 to an outlet 66 that opens into the first chamber 60.

Venting openings 68 are provided so that air is able to vent from the second chamber 62.

The manner of operation and use of the compressed air discharge device 1 will now be described.

In use, the device 1 is connected to a supply of compressed air. This is done by a hose connected to the inlet 6.

FIGS. 4 and 7 show the device 1 in a condition in which the trigger 36 is not depressed. In this condition both the first and second valves 18 and 20 are closed.

Once the device 1 has been fixed in position ready for discharge of air therefrom, an operator grips the device 1 by the handle 4 and squeezes the trigger 36. Squeezing the trigger 36 causes the pin 32 to move in the opening 34 and the valve head 22 moves away from the valve seat 24, in the direction of Arrow T in FIG. 8, against the biasing action of the spring 26. This condition is shown in FIG. 8.

Air is then able to flow through the open valve 18 from the first passage 10 and into the second passage 12 and the third passage 14. The air flow in the first passage 10, through the open valve 18 and into the second passage 12 is shown by arrows A in FIG. 8. Air entering the third passage 14 is initially unable to flow beyond the second valve 20 since the air initially entering the third passage 14 acts in a direction to maintain the valve head 44 against the valve seat 46, i.e. to maintain the second valve 20 in the closed position.

Once the valve head 22 starts to move away from the valve seat 44, air is able to enter the second passage 12 and flow along the second passage 12 toward the first chamber 60. FIG. 8 shows the condition in which the trigger 36 has just been squeezed to open the first valve 18 to allow air to flow through the open first valve 18 and into the second passage 12, but in which the air has not yet entered the chamber 60 to move the piston 56. That is, FIG. 8 shows the condition of the device 1 just prior to the condition shown in FIG. 5. Once air enters the chamber 60 from the outlet 66 of the second passage 12, the piston 56 moves in the direction of Arrow V shown in FIG. 5 from a first position (FIG. 8) to a second position (FIG. 5). Since the piston 56 is connected with the valve head 44 by the valve stem 50, the valve head 44 of the second valve 20 moves away from the valve seat 46 against the biasing action of the spring 48 in the direction of Arrow V. This allows air to flow from the third chamber 14 through the open second valve 20 and along the fourth passage 16 in the direction of Arrow F, which is opposed to the direction of Arrow V. The air then flows from the outlet 8 of the device 1.

The air flow in the first passage 10, through the open valve 18 and into the third passage 14 is shown by Arrows A in FIG. 5. The air flow from the third passage 14 through the open valve 20 and into the fourth passage 16 is shown by Arrow B in FIG. 5.

In real time, the delay between the operator squeezing the trigger 36 and the air being discharged from the outlet 8 is virtually unnoticed. The delay results from the time it takes for air to flow into the second passage 12 and then into the chamber 60 to move the piston 56 to thereby open the second valve 20.

The compressed air discharge device of the present invention is able to discharge compressed air at a relatively high pressure, e.g. 250 psi, and allows the operator to maintain the trigger 36 in a depressed condition (to maintain the first valve 18 in an open condition) with minimal finger pressure on the trigger 36.

As air flows into the first chamber 60 and the piston 56 moves in the direction of Arrow V, the first chamber 60 increases in volume. This can be seen from FIGS. 8 and 5. As this occurs, the second chamber 62 decreases in volume. The venting openings 68 at the rear of the device 1 allow the air to be vented from the chamber 62 as the volume of the chamber 62 decreases.

When the trigger 36 is released, the spring 28 pushes the valve head 22 of the first valve 18 back against the valve seat 24. This then closes the first valve 18 and prevents air flow therethrough. Thus, air no longer flows from the first passage 10 to the second and third passages 12 and 14. Since there is then not sufficient air pressure in the first chamber 60 to act against the piston 56, the spring 48 of the second valve 20 pushes the valve head 44 of the second valve head 20 against the valve seat 46. This causes the piston 56 to move in the same direction as the valve head 44, i.e. in the direction opposed to Arrow V, or alternatively, in the direction of Arrow F. The volume of the first chamber 60 decreases and the volume of the second chamber 62 increases. Air can be drawn into the second chamber 62 from ambient by passing through the venting openings 68 in the reversed direction. The device 1 is thereby returned to the condition shown in FIGS. 4 and 7.

Modifications and variations such as would be apparent to the skilled addressee are considered to fall within the scope of the present invention.

Throughout the specification, unless the context requires otherwise, the word “comprise” or variations such as “comprises” or “comprising”, will be understood to imply the inclusion of a stated integer or group of integers but not the exclusion of any other integer or group of integers.

1. Compressed air discharge device characterised in that it comprises
an inlet for entry of air into said device,
an outlet for discharge of air from said device,
first, second, third and fourth passage means for flow of air,
first valve means to control flow of air from said first passage means to said third passage means,
second valve means to control flow of air from said third passage means to said fourth passage means,
said first passage means provided between said inlet and said first valve means, said third passage means provided between said first and second valve means, and said fourth passage means provided between said second valve means and said outlet,
trigger means operable to open said first valve means to allow air to flow therethrough into said second and third passage means,
said second passage means arranged such that air is able to enter said second passage means upon said first valve means being opened,
a chamber formed within said device and said second passage means leading to said chamber, and
piston means movable by air entering said chamber,
wherein, in use, operation of said trigger means opens said first valve means to allow air to flow therethrough from said first passage means into said second and third passage means, and air flows along said second passage means to said chamber to cause said piston means to move in a first direction from a first position to a second position which causes said second valve means to open and allow air to flow therethrough from said third passage means to said fourth passage means and to be discharged from said outlet.

2. Compressed air discharge device according to claim 1. characterised in that the inlet to said second passage means is provided adjacent said first valve means.

3. Compressed air discharge device according to any one of the preceding claims, characterised in that the air that flows into said third passage means from said first passage means upon said first valve means being opened, acts to maintain the second valve means in a closed condition until said second valve means is opened.

4. Compressed air discharge device according to any one of the preceding claims, characterised in that a second chamber is provided on the side of said piston means opposed to said chamber and said second chamber is provided with venting means.

5. Compressed air discharge device according to any one of the preceding claims, characterised in that said first direction is opposed to the direction of air flow along said fourth passage means.

6. Compressed air discharge device according to any one of the preceding claims, characterised in that said second valve means comprises a valve head and a valve seat, and a valve stem extends from said valve head and is attached to said piston means.

7. Compressed air discharge device according to claim 6, characterised in that when said second valve means opens, said valve head moves in said first direction which is opposed to the direction of air flow along said fourth passage means.

8. Compressed air discharge device according to any one of the preceding claims, characterised in that said first and second valve means are biased into respective closed positions.

9. Compressed discharge device according to claim 8, characterised in that said first and second valve means are provided with spring means to bias them into their closed positions.
